(19) United States
(12) Patent Application Publication
(10) Pub. No.: US 2018/0329907 A1
(43) Pub. Date: Nov. 15, 2018

(54) REDUCING DATA SENT FROM A USER DEVICE TO A SERVER

(71) Applicant: NEURAL TECHNOLOGY LIMITED, London (GB)

(72) Inventor: Timothy Andre William George De Paris, London (GB)

(73) Assignee: NEURAL TECHNOLOGY LIMITED, London (GB)

(21) Appl. No.: 15/817,032

(22) Filed: Nov. 17, 2017

(30) Foreign Application Priority Data
Nov. 18, 2016 (GB) 1619499.5

(51) Int. Cl. G06F 17/30; H04L 29/08

(52) U.S. Cl. CPC G06F 17/3033; H04L 67/10; G06F 17/30896; G06F 17/30377

(57) ABSTRACT

A method comprises: sending at a server to one or more user devices first data and group of first hashes, the group comprising a subset of first hashes stored in a hash store. Each first hash is stored in association with a respective first data portion. The server subsequently receives from each user device one or more second hashes and second data. The first data has been modified at the user device and the second data comprises the modified first data excluding one or more second data portions from which each second hash can be hashed. For each second hash, an indication that the second hash has been received with the matching, is then associated with the stored first hash. Based on the indications, the group is updated to comprises first hashes that are more likely to be received than the first hashes not in the group.

### RELATED APPLICATIONS

This application claims benefit of foreign application Serial No. GB1619499.5 filed on Nov. 18, 2016 which is incorporated by reference as if fully set forth herein.

### FIELD OF THE INVENTION

The invention relates to reducing the amount of data sent at a user device to a server means, particularly where the server means also receives data from other user devices and a portion of the received data from the other user devices is the same as a portion of the data received from the user device.

### BACKGROUND

Due to limitations on bandwidth, there is a general desire to minimise the amount of data sent over networks. There is also a desire not to store duplicated data on servers.

An object of the present invention is to reduce the amount of data that needs to be sent from user devices to servers in particular scenarios. Another object of the present invention is to reduce the amount of data that needs to be stored at servers in particular scenarios.

### SUMMARY

In accordance with a first aspect of the present invention, there is provided a method comprising: sending at a server means to one or more user devices first data and group of first hashes, the group comprising a subset of first hashes stored in a hash store, wherein each first hash is stored in association with a respective first data portion from which the first hash can be hashed using a hash function; receiving at the server means from the or each user device one or more second hashes and second data, wherein the first data was modified at the user device and wherein the second data comprising the modified first data excluding one or more second data portions from which the or each second hash can be hashed, and wherein the or each second hash matches one of the first hashes in the group; for the or each second hash, associating, at the server means, an indication that the second hash has been received with the matching, stored first hash; based on the indications, updating the group to comprises first hashes that are more likely to be received than the first hashes not in the group.

Thus, the group of first hashes dynamically updates. This results in the group of hashes subsequently sent to other user devices being more likely to be relevant, such that second hashes generated at the other user devices are more likely to match with the first hashes in the group. This advantageously means that, in order for the modified first data to be derivable from information received at the server means, only the modified first data excluding certain data portions, and the second hashes hashed from those data portions, need to be received—the actual data portions do not have to be transmitted. In a scenario in which the way in which the first data is modified changes with time, dynamical updating of the group of first hashes is highly advantageous as otherwise the first hashes in the group may lose relevance.

The method may further comprise sending to the or each user device a computer program product which, when executed at the respective user device, is configured to: process the modified first data to generate data portions; generate a second hash for the or each data portion using the hash function; compare the or each second hash with the first hashes in the group; for any second hashes that match with a first hash, cause sending to the server means of the or each second hash.

The sending may further comprise sending to a plurality of the user devices, and the receiving comprises receiving from each of a plurality of the user devices. The receiving of the one or more second hash may comprise receiving a plurality of second hashes.

The updating may comprise: determining, based on the indications, for each stored first hash likelihood information indicative of a likelihood of the particular first hash being received relative to other of the first hashes; based on the likelihood information, updating the group to comprises first hashes that are more likely to be received than the first hashes not in the group.

The determining for each stored first hash the likelihood information may comprise determining if the indications associated with the stored hash meet at least one criterion. The determining if the at least one criterion is met may be based at least on determining if the number of indications associated with the particular first hash relative to the number of indications associated with all first hashes is above a threshold value. The determining if the number of indications associated with the particular first hash relative to the number of indications associated with all first hashes is above the threshold value may be over a predetermined time period.

The associating an indication that a second hash has been received with the matching stored hash may comprise incrementing a counter associated with the matching stored first hash. An indication of the time at which a second hash has been received may also be stored in association the stored matching first hash.

The method may further comprise: receiving at the server means from the one or more user devices one or more further second hash and, for the or each further second hash, an associated data portion; comparing the or each received further second hash with the first hashes stored in the hash store; if the or any further second hash does not match any of the stored first hashes, adding the or each non-matching further second hash in association with the associated data portion to the hash store.

The method may further comprise, if the or any further second hash matches any of the stored first hashes, associating with the matched stored first hash an indication that a hash matching the matched stored hash has been received. The or each further second hash may not match with any first hash in the group of hashes.

The method may further comprise: storing the second data and the second hashes. In this case the second data and the second hashes can be used, with the hash store to determine the modified first data. The method may further comprise storing the further second hashes.

The method may comprise the method described above, and optional and/or preferred features thereof, performed repeatedly. In this case the sending of the group to the one or more user devices comprises sending of the updated group.

In accordance with a second aspect of the present invention, there is provided a method comprising: sending at a server means to one or more user devices first data and group of first hashes, the group comprising a subset of first hashes stored in a hash store, wherein each first hash is stored in association with a respective first data portion from which the first hash can be hashed using a hash function; receiving at the server means from the or each user device one or more second hashes and, for the or each second hash, a data portion from which the second hash can be generated using the hash function, wherein the or each second hash does not match with any first hash in the group; determining for the or each second hash whether the second hash matches with one of the first hashes in the hash store; if the respective second hash does not match with any of the first hashes, adding the second hash to the hash store as a first hash, in association with the associated data portion; updating the group to comprises first hashes that are more likely to be received than the first hashes not in the group.

This method results in the group being updated so that the group may include hashes for data portions that were unknown when the process is initiated.

If, based on a result of the determining, the respective second hash matches one of the first hashes in the hash store, the method may comprise associating, at the server means, an indication that the second hash has been received with the matching, stored first hash. In this case the updating the group is based on the indications.

The method may further comprise: sending to the or each user device a computer program product which, when executed at the respective user device, is configured to: process the modified first data to generate data portions; generate a second hash for the or each data portion using the hash function; compare the or each second hash with the first hashes in the group; determine that the or each second hash does not match with any of the first hashes in the group; and cause sending of the or each second hash and, for the or each hash, the associated data portion.

The sending may comprise sending to a plurality of the user devices, and the receiving comprises receiving from each of a plurality of the user devices. The receiving of the one or more second hash may comprise receiving a plurality of second hashes.

The updating may comprise: determining, based on the indications, for each stored first hash likelihood information indicative of a likelihood of the particular first hash being received relative to other of the first hashes; based on the likelihood information, updating the group to comprises first hashes that are more likely to be received than the first hashes not in the group. The determining for each stored first hash the likelihood information may comprise determining if the indications associated with the stored hash meet at least one criterion.

The determining if the at least one criterion is met may be based at least on determining if the number of indications associated with the particular first hash relative to the number of indications associated with all first hashes is above a threshold value. The determining if the number of indications associated with the particular first hash relative to the number of indications associated with all first hashes is above the threshold value may be over a predetermined time period.

The associating an indication that a second hash has been received with the matching stored hash may comprise incrementing a counter associated with the matching stored first hash. An indication of the time at which a second hash has been received may also be stored in association the stored matching first hash.

The method may further comprise storing the second data and the second hashes such that the second data and the second hashes can be used, with the hash store, to determine the modified first data.

In accordance with a third aspect of the present invention, there is provided a method comprising: receiving from a server means, at a user device, first data and a plurality of first hashes, wherein the first hashes are each stored in association with respective second data from which the first hash has been generated using a hashing function; modifying the first data at the user device; hashing at least one portion of the modified first data to generate at least one second hash using the hashing function; determining that at least one of the second hashes matches one of the first hashes; sending information indicative of the matched hashes and the modified first data excluding the portion to the server means, thereby enabling the server means to determine the modified first data.

The method may further comprise before hashing the at least one portion of the modified first data, determining at least one portion of the first data to be hashed. The method may further comprise cleaning the first data before determining at least one portion of the first data to be hashed.

The hashing at least one portion may comprise hashing a plurality of portions, wherein at least one of the second hashes does not match to any of the first hashes. In this case the method may further comprise: sending the at least one unmatched second hash and a copy of the portion associated with the or each unmatched second hash to the server means.

The method may further comprise, at the server means: receiving a copy of the or each unmatched second hash and the associated portions; comparing the unmatched second hashes with first hashes in a hash store in which the first hashes are mapped to the second data; if any of the unmatched second hashes does not match to one of the first hashes, adding the second hash and the corresponding data portion to the hash store as, respectively, a first hash and second data.

If any of the unmatched second hashes matches to a one of the first hashes, the method may comprise incrementing a counter associated with the matched first hash.

The method may further comprise: receiving the matched second hashes at the server means from the user device; determining, for each matched second hash, a one of the first hashes to which the matched second hash matches; incrementing a counter associated with the matched first hash.

The first data may comprise webpage code renderable by a web browser running on the user device, and wherein the modifying the first data may comprise rendering the webpage code. The method may comprise, before determining a portion of the first data to be hashed: copying the rendered webpage code to a separate memory location.

The determining a portion of the first data to be hashed may comprise determining an element of a DOM or render tree deriving from the first webpage code. In this case, the hashing comprises hashing the element. The determining the portion of the first computer program code may comprise determining an element of a DOM deriving from the first computer program code using one of: a predetermined selector; a predetermined element identifier; a predetermined path identifying the element.

The determining the portion of the first computer program code may comprise determining an element of a DOM deriving from the first computer program code using an element that has at least a threshold number of child elements.

The determining the portion of the first computer program code may comprise determining an element of a DOM deriving from the first computer program code by determining that an element in the DOM is a predetermined depth from a root of the DOM.

The determining a portion of the first computer program code to be hashed may comprise determining an element of render tree deriving from the first computer program code comprising an encoded image.

In accordance with a fourth aspect of the present invention, a method may comprise: receiving at a server means one or more hash from one or more user device, the or each hash being associated with a respective data portion; comparing the or each received hash with hashes stored in a hash store, wherein the stored hashes are each associated with a respective data portion from which the respective hash is generated; if any of the received hashes matches one of the stored hashes, associating with the matched stored hash an indication that a hash matching the matched stored hash has been received.

In accordance with a fifth aspect of the present invention, a method receiving at a server means one or more hash and, for the or each hash, an associated data portion from which the or each hash is hashed from one or more user device; comparing the or each received hash with hashes stored in a hash store, wherein the stored hashes are each associated with a respective data portion from which the respective stored hash is generated; if any received hash does not match with any stored hash, adding the received hash to the hash store in association with the respective data portion.

In the methods of the first, second, fourth and fifth aspects, the first data may comprise webpage code renderable by a web browser running on the user device, and the modifying the first data may comprise rendering the webpage code. In this case, the second hash may be hashed from an element of a DOM or render tree deriving from the first webpage code.

There is also provided a computer program product comprising computer program code stored on a computer readable storage medium, wherein, when executed in by a processor at a user device the code is configured to cause the method of any one of aspects of the invention to be performed.

### BRIEF DESCRIPTION OF THE FIGURES

For better understanding of the present invention, embodiments will now be described, by way of example only, with reference to the accompanying Figures in which:

FIG. 1 is a diagrammatic view of apparatus in which embodiments of the invention may be implemented;

FIG. 2 is a flowchart indicating steps in accordance with embodiments of the invention;

FIG. 3 is a flowchart indicating an updating process that takes place at a server; and

FIG. 4 is a flowchart indicating a process by which a frequent hash list is created.

### DETAILED DESCRIPTION OF THE PREFERRED EMBODIMENTS

Like reference numerals are used to denote like parts and steps throughout.

Generally, embodiments of the invention may be implemented in a scenario where a server sends source data to multiple user devices, the source data may be modified by each user device to result in modified data that is different on at least some of the user devices, and it is wanted for the server to have a copy of the modified data that each device produces without every user device sending a complete copy of the modified data to the server. This is achieved by storing portions of modified data received from one or more of the devices at the server each in association with a hash generated by hashing the portion using a predetermined hash function. Copies of at least some of the stored hashes are sent to other of those user devices together with the source data. The source data is then modified at the other user devices and portions of the modified data are hashed using the same hashing function. If a hash generated at a user device matches one of the received hashes, this implies that the portion of modified data from which the hash was generated is stored at the server. Accordingly, a copy of the hash or other information indicative of the particular hash may be sent to the server in place of the actual portion of the modified data.

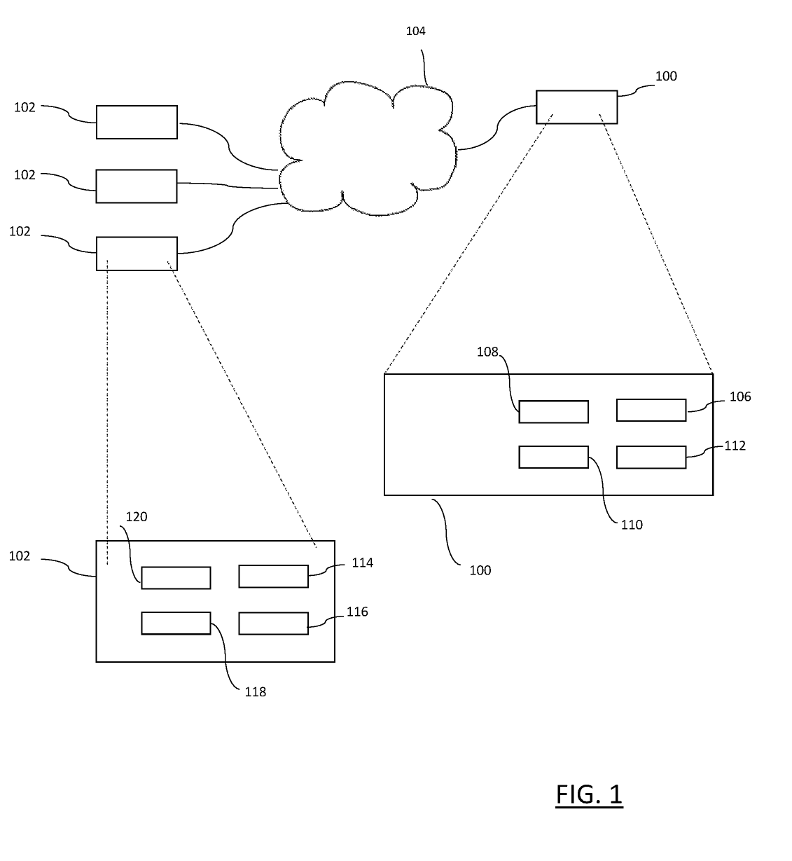

Referring to FIG. 1, in an embodiment, a server 100 is configured for communication with a plurality of user devices 102 via a communications network 104. Although three user devices are shown, in practice there may be greater or fewer than three.

The communications network 104 may be the internet, but is not limited to a particular kind of network. Embodiments of the invention are not limited to communication using any particular protocol suitable for transmitting and receiving data. The communications network 104 may comprise a plurality of connected networks. For example, communication may be via the internet to which the server 100 is connected and a local area network or a cellular telecommunications network to which the user device 102 is connected.

Components of the server 100 includes a processor 106, for example a CPU, a memory 108, a network interface 110 and input/output ports 112, all operatively connected by a system bus (not shown). The memory may comprise volatile and non-volatile memory, removable and non-removable media configured for storage of information, such as RAM, ROM, Erasable Programmable Read Only Memory (EPROM), Electrically Erasable Programmable Read Only Memory (EEPROM), flash memory or other solid state memory, CD-ROM, DVD, or other optical storage, magnetic disk storage, magnetic tape or other magnetic storage devices, or any other medium which can be used to store information which can be accessed. The processor may comprise a plurality of linked processors. The memory may comprise a plurality of linked memories. Other components may also be present. A computer program comprising computer program code is provided stored on the memory 108. The computer program, when run on the processor 106, is configured to provide the functionality ascribed to the server 100 herein.

Each user device 102 may be a personal computer, laptop, smartphone, tablet, for example. Each user device 102 comprises a processor 120, a memory 114, optionally input/output ports 116, and a sending and receiving apparatus 118. As will be understood by the skilled person, the user device 102 would in practice include many more components.

The server 100 is configured to send source data, a sent data reduction (SDR) program and a list of hashes to the user devices 102. The source data that is sent to each device may be the same or may have parts in common.

The server 100 is also configured to handle data portions and hashes received from the user devices 102 and to store the hashes each in association with a respective data portion from which the hash was generated at a user device in a hash data store.

The server 100 is also configured to receive from the user devices data packages containing a) information from which the modified data can be recreated, and b) information enabling creating and updating of the hash store. The hash store is preferably located in the memory 108 of the server 100, but may alternatively be located remotely.

In addition to listing hashes each associated with the data portion from which the hash was generated using a predetermined hashing function, the hash store includes, for each hash, a counter. The server 100 is configured to determine when a hash is received from a user device 102 and to increment the counter associated with that hash each time a hash is received from a user device. In the event that the server 100 receives a hash and a data portion from which the hash was generated, and that hash is not already stored in the hash store, the server 100 is configured to update the hash store by adding the received hash and data portion to the hash store.

The server 100 is also configured to maintain in the hash store a list of hashes that are commonly received from user devices 102. This list (“frequent hash list”) is a subset of all the hashes stored at the server 100. The server 100 is configured to create and update the frequent hash list based on the values of the counters. The hashes in the frequent hash list are herein referred to as “first hashes”.

The source data received by a user device 102 may be modified by the user device 102. With the aim of providing to the server 100 information from which the server 100 can derive a copy of the modified data, the SDR program is configured to perform several actions.

The SDR program sent to the user device 102 includes the frequent hash list. The SDR program comprises computer program code which, when executed at the user device, causes the functionality ascribed to the SDR program herein to take place. The SDR program may be sent to the user device 102 separately to the source data, or may be attached to the source data. The SDR program may also be in the form of a computer program (an “app”) installed on the user device 102. In this case, the frequent hash list may be stored as part of the app and periodically be synchronised with a frequent hash list at the server 100.

The SDR program, when executed at a user device 102, is configured to determine portions of the modified data for hashing. This may be done in various ways. For example, where the data includes an image, a portion may be determined to be that image. Where the data includes a file or folder, a portion may be determined to be that file or folder. Various rules may be configured in the SDR program as to identification of portions, for example dependent on kind of data, data size, et cetera.

The SDR program is configured to hash each of the identified portions using a hashing function to generate corresponding second hashes. The SDR program is configured to compare the second hashes to the first hashes in the frequent hash list. The hashing function from which first hashes were hashed and that s included with the SDR program for generating the second hashes is the same.

The SDR program is configured to cause sending of information indicative of the modified data to the server 100. If any of the second hashes match, that is, are the same as one of the first hashes in the frequent hash list, the SDR program is configured to send the modified data, excluding the portions of the modified data for which corresponding second hashes were matched, to the server 100, together with a copy of the matched second hashes. The SDR program is also configured to send to the server 100 a copy of all the second hashes that do not match with any of the first hashes in the frequent hash list, together with a copy of the data portion from which the unmatched second hash was generated. This enables the server 100 to establish or update the hash data store.

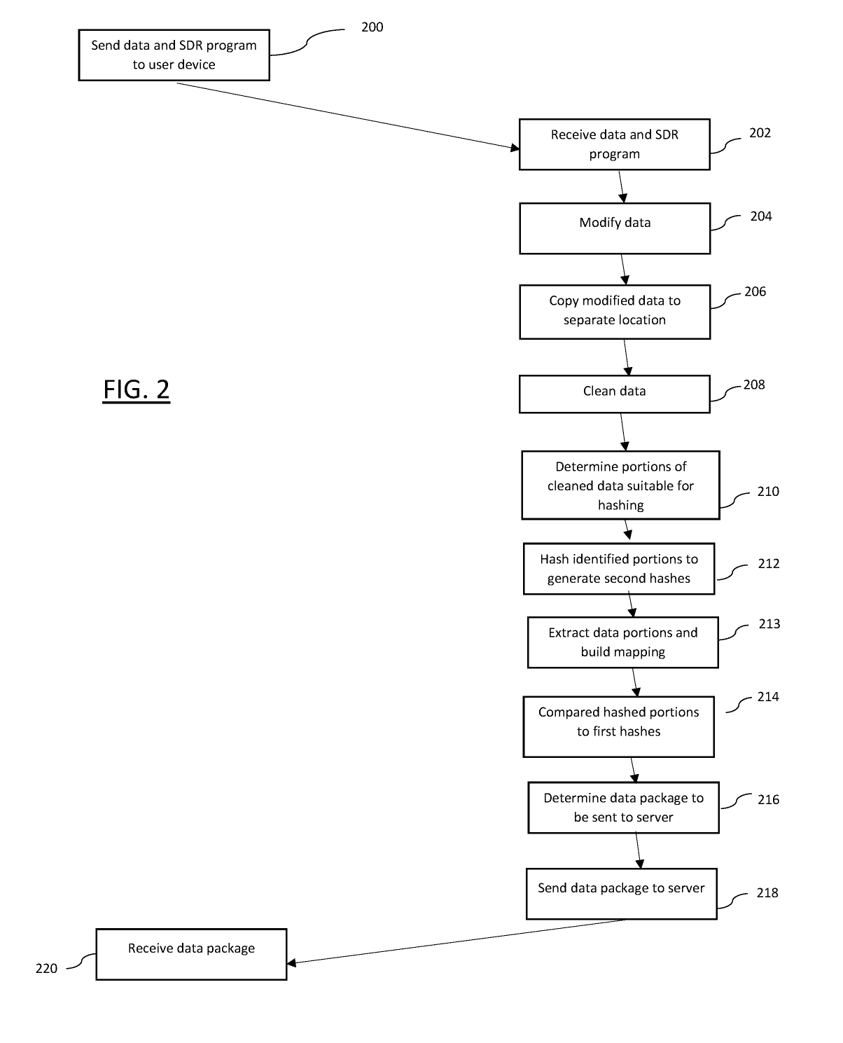

An exemplary process in which source data is sent from the server 100 to a one of the user devices 102, is then modified, and information indicative of the modified source data sent back to the server 100 is now described with reference to FIG. 2. At step 200, the server 100 sends the source data, the frequent hash list and the SDR program to the user device 102. The user device 102 receives the source data, the frequent hash list and the SDR program at step 202. The user device 102 then processes the source data, and in doing so modifies it at step 204.

When the source data is processed and modified, changes may be made to the data that depend on the particular user device 102 on which the data is processed, for example on the particular device, the operating system, and user preference information. Although not essential to all embodiments, the modified data is cleaned so that the modified data on which step 210 is performed more closely resembled modified data if such data is modified on other of the user devices 102. The data may also or alternatively be cleaned for other reasons.

Before cleaning the data, the user device 102 copies at step 206 the modified data to a separate location in the memory so that the data can be cleaned. The modified data is then cleaned at step 208. For example, where the data comprises computer program code, white spaces may be removed. Comments included by a person who wrote the program may also be removed.

After the modified data has been cleaned, the SDR program determines portions of the cleaned data that are suitable for hashing at step 210.

The SDR program then hashes each of the determined portions using the hash function to generate a second hash for each determined portion at step 212.

At step 213, the SDR program extracts the determined data portions and builds a mapping between those data portions and the second hashes. The SDR program then compares at step 214 each of the second hashes with the received first hashes and determines whether each of the second hashes is the same as any one of the received first hashes.

If a second hash matches any one of the first hashes, this indicates that the data portion corresponding to that second hash is stored in the hash store at the server 100. If a second hash does not match any of the first hashes, this indicates that the portion of the cleaned data from which that second hash was generated may not be stored in the hash store at the server 100, and at least that the second hash is not on the frequent hash list.

The SDR program then determines at step 216 the contents of a data package to send to the server 100, so that the server 100 can determine the cleaned, modified data. If one or more second hashes each matched to one of the first hashes, the SDR program causes the user device 102 to include in the package a copy of the cleaned data excluding the portions corresponding to the matched second hashes.

If none of the second hashes has matched with the first hashes, the SDR program creates a package including the cleaned, modified data in its entirety, together with a copy of the generated second hashes each mapped to the respective portion of the cleaned, modified data from which it was hashed.

The data package is then sent to the server 100 at step 218 and received at step 220 by the server 100. The server 100 then stores the received modified data excluding the portions that have been hashed and for which the second hashes matched a first hash in the frequent hash list, together with a copy of each such second hash, such that the modified data can be recreated.

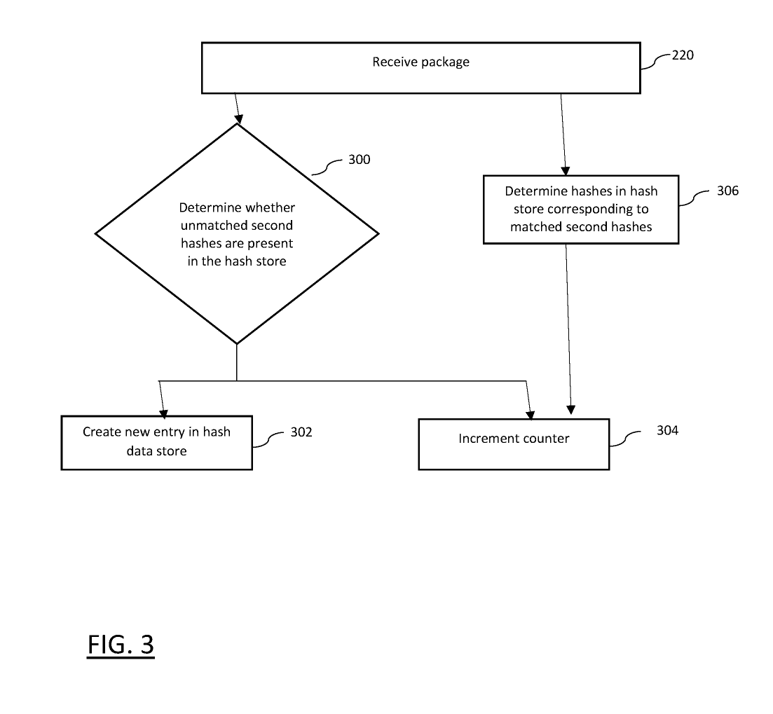

A process by which the hash data store is created and updated is now described with reference to FIG. 3. Thus, the server 100 receives the second hashes from the user device 102 at step 220. The second hashes are in two groups: those that were each matched against one of the first hashes in the frequent hash list, and those that were not.

For the former, the server 100 determines at step 306, for each second hash, the location of the corresponding stored hash in the hash data store, and increments the corresponding counter at step 304. For the latter, the server 100 determines at step 300, whether the second hash is present in the hash store. If the hash is present, the server 100 increments the corresponding counter at step 304. If the hash is not present, the server 100 adds a copy of the received second hash and the associated data portion to the hash data store at step 302 and associates a counter with each second hash, where the counter is initiated at “1”. These second hashes can thereafter be considered to be first hashes.

Initially, when the system is first launched, the hash data store may be empty. In this case, the frequent hash list will also be empty. In this case, on receiving second hashes and associated data portions from the user device 102, the server 102 will populate the hash store with hashes and corresponding data portions.

An updating process is run periodically, for example hourly, at the server 100 to update the list of hashes that are included in the frequent hash list, based on the value of the counters. Alternatively, the updating process may run each time any of the counters are updated and a new hash is added.

A specific implementation of the embodiment described above is now described, by way of example only. In this implementation, the server 100 includes functionality of a web server, and the source data that is sent from the server 100 to the user device 102 is webpage code by which a viewable webpage can be displayed

Webpage code includes HTML code or a variant thereof. HTML is composed of a tree of HTML elements and other nodes, such as text nodes. Each element can have HTML attributes specified. The nodes of every HTML document are organized in a tree structure, called the Document Object Model (DOM) tree, with a topmost node named the “Document object”. The DOM defines the logical structure of HTML documents. The DOM represents the relationships between elements in HTML documents. When an HTML page is rendered in a browser by a rendering engine, the browser downloads the HTML into the memory and automatically renders it to display the page on the display of the user device.

To render the HTML, the web browser initially parses the HTML and creates a DOM tree. CSS attributes (style attributes) are also parsed and then combined with the DOM tree to create a “render tree”. This is a tree of visual elements such as height/width and colour ordered in a hierarchy in which they are to be displayed in the web browser.

After the render tree is constructed, the rendering engine recursively goes through the HTML elements in the render tree and determines where the HTML elements should be placed on the display of the user device 102. This starts at the top left in position 0,0 and elements and attributes are mapped to coordinates on the display.

The web browser displays each node of the render tree on the display by communicating with an Operating System Interface of the user device 102, which contains designs and styles for how user interface elements should look.

The webpage code has appended the SDR program mentioned above, which is implemented in JavaScript. The SDR program is configured to interact with the Document Object Model (DOM) of the webpage.

Operation of a system will now be described, with reference to the steps mentioned above in relation to FIG. 2. The same webpage code may be rendered differently by the same or different web browsers on the same or different devices. The webpage code that is sent to each user devices 102 may also be different. For example, webpage code may be different if a website owner is doing A/B or multivariate testing. First, the server 100 sends the webpage code to the user device 102 at step 200, which the user device 102 receives at step 202.

In step 204, the web browser running on the user device 102 then renders the webpage (“rendered webpage code”), such that the displayed webpage may look different to a webpage displayed from the same webpage code on different devices.

The displayed webpage may look different for one or more of the following reasons. The displayed page may be rendered using a dynamic content rendering technique, such as AJAX. An in-browser extension may strip or inject content into the webpage. The webpage may be personalised by the web browser.

In step 206, the SDR program copies the code of the rendered webpage, representing the content displayed to a user, into a local data store at the user device 102.

In step 208, operations are performed on the stored code to clean the code, that is, to try to standardise the code, for example to remove differences that arise in the code due to the use of different browsers, different versions of browsers, different devices, and user preferences. The storing of the copy of rendered webpage code in the local data store means that the code can be modified without impact of the experience of the user viewing the webpage.

To clean the code, the webpage processing code may determine white spaces in the code that are extraneous, and remove them. The webpage processing code may identify explanatory comments in the HTML code that have been left by a software developer, and remove them. The webpage processing code may identify irrelevant tags, such as <script> tags, and remove them.

Embodiments of the invention are not limited to the cleaning tasks mentioned above. Other operations may be performed on the stored code to remove features of the code arising from the particular environment.

In step 210, portions of the cleaned code that are suitable for hashing are then identified. This identification may be done using any one or more of the following mechanisms:
Identifying embedded resources such as CSS (cascading style sheets) and/or BASE64 encoded images;
Identifying elements that match specific selectors, identifiers or paths;
Identify elements that contain a large number of child elements;
Identify elements that are a specified depth from the document root.

Variant embodiments may use additional or alternative mechanisms for identifying elements.

In step 212, the identified data portions are hashed using the hash function, for example an md5 hash function. This generates a second hash for each identified data portion.

In step 213, the SDR program extracts each identified portion from the copied code and builds an in-memory map containing the second hashes mapped to the respective data portion.

In step 214, the SDR program compares each of the second hashes to the first hashes listed in the frequent hash list. If a second hash matches any of the first hashes, the data portion for that second hash is removed from the in-memory map.

In step 216 determines the package to be sent to the server 100. The SDR program sends the remaining (non-removed) data portions, and the list of second hashes, and any cleaned HTML code that was not identified and thus not hashed, to the server 100 using an XHR request or other similar mechanism at step 218. The data may be sent using an XHR request (XMLHttpRequest). The XHR request is an API available to the SDR program and causes sending using HTTP or HTTPS requests. Other sending methods may be used in place of the XHR request.

The server 100 then receives these and stores them at step 220. The code that was not hashed is then stored in a database, where it is linked to a unique identifier for the user, an identifier of the session and an identifier of the pageview.

To continue this specific example with reference to FIG. 3, the server 100 then processes each second hash in the map of hashes and data portions. For each data portion in the map, the server 100 links the corresponding second data to the unique identifiers for the user, the session and the pageview, and a timestamp indicating the time at which the pageview occurred. Thus a record is retained of the webpage in the form in which the user viewed it.

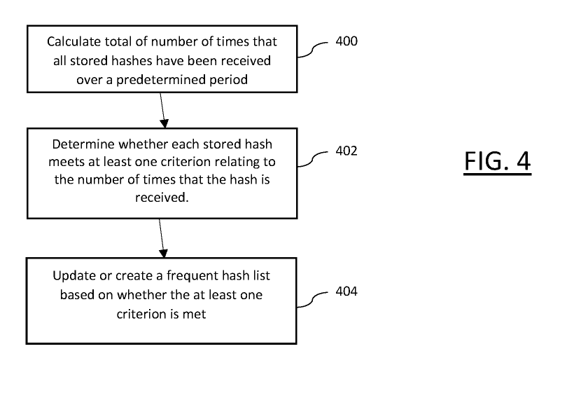

Referring to FIG. 4 in which the updating process at the server 100 by which the frequent hash list is generated is now described. The updating process is run periodically. The aim of the updating process is for the server 100 to maintain a list of stored hashes that are regularly matched at user devices to hashes generated from data portions of the source data. The list (“frequent hash list”) can then be sent with the source data to other user devices, as described above. By limiting the number of hashes sent to the user devices, sending of all the stored hashes to the user devices with the source data is avoided, since the number of hashes stored in the hash store may become cumbersome.

First, as indicated at step 400, a cumulative total of all the counters associated with the stored hashes is determined, which indicates the total number of times that all hashes have been received. The total may be determined over a predetermined period. At step 402, it is determined whether at least one criterion is met relating to the frequency that each hash is received relative to other stored hashes. Thus, a proportion that a hash is received relative to the total number of times that all hashes are received may be calculated. In this case, the at least one criterion may require that the proportion be greater than a threshold proportion, for example 10%. In variant embodiments, other ways of defining when a hash received from a user device is sufficiently common that it is included in the list of hashes in the SDR program may be provided.

At step 404, the frequent hash list is updated, or replaced, to include the hashes that have met the at least one criterion.

Rules may be stored and periodically applied to the hash store. For example, each counter may be configured to reduce over time, or to keep a record of when a new count was added and to remove that count after a predetermined period, for example a week has expired.

Embodiments of the invention may be used in the various scenarios where data is sent by a data owner to user devices, the data is modified at the user devices and the data owner wants to have a record of the modified data. Embodiments of the invention advantageously enable the data owner to obtain such a record without a whole copy of the modified data being sent by each user device. In particular, where the data owner is a website owner or developer there is particularly value in the field of analytics in having a record of what is actually displayed to the user.

It will be appreciated by persons skilled in the art that various modifications are possible to the embodiments.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising:
sending at a server unit to one or more user devices first data and a group of first hashes, the group comprising a subset of first hashes stored in a hash store, wherein each first hash is stored in association with a respective first data portion from which the first hash can be hashed using a hash function;
receiving at the server unit from the or each user device information indicative of one or more second hashes, and second data, wherein the first data was modified at the user device and wherein the second data comprising the modified first data excluding one or more second data portions from which the or each second hash can be respectively hashed using the hash function, and wherein the or each second hash matches one of the first hashes in the group;
for the or each second hash indicated in the received information, associating, at the server unit, an indication that the second hash was matched to with the matching, stored first hash;
based on the indications, updating the group to comprise first hashes that are more likely to be received than the first hashes not in the group.

2. The method of claim 1, further comprising sending to the or each user device a computer program product which, when executed at the respective user device, is configured to:
process the modified first data to generate data portions;
generate a second hash for the or each data portion using the hash function;
compare the or each second hash with the first hashes in the group;
for any second hashes that match with a first hash, cause sending to the server unit of the information indicative of the or each second hash.

3. The method of claim 1, wherein the updating comprises:
determining, based on the indications, for each stored first hash likelihood information indicative of a likelihood of the particular first hash being received relative to other of the first hashes;
based on the likelihood information, updating the group to comprise first hashes that are more likely to be received than the first hashes not in the group.

4. The method of claim 1, wherein the determining for each stored first hash the likelihood information comprises determining if the indications associated with the stored hash meet at least one criterion.

5. The method of claim 4, wherein the determining if the at least one criterion is met is based at least on determining if the number of indications associated with the particular first hash relative to the number of indications associated with all first hashes is above a threshold value.

6. The method of claim 5, wherein the determining if the number of indications associated with the particular first hash relative to the number of indications associated with all first hashes is above the threshold value is over a predetermined time period.

7. The method of claim 1, wherein the associating an indication that the second hash with the matching stored first hash comprises incrementing a counter associated with the matching stored first hash.

8. The method of claim 7, wherein an indication of the time at which a second hash has been received is also stored in association the stored matching first hash.

9. The method of claim 1, further comprising:
receiving at the server unit from the one or more user device one or more further second hash and, for the or each further second hash, an associated data portion;
comparing the or each received further second hash with the first hashes stored in the hash store;
if the or any further second hash does not match any of the stored first hashes, adding the or each non-matching further second hash in association with the associated data portion to the hash store.

10. The method of claim 9, further comprising:
if the or any further second hash matches any of the stored first hashes, associating with the matched stored first hash an indication that a hash matching the matched stored hash has been received.

11. The method of claim 1, further comprising: storing the second data and the second hashes, wherein the second data and the second hashes can be used, with the hash store to determine the modified first data.

12. A method comprising:
the method of claim 1;
repeating the method of claim 1, wherein the sending of the group to the one or more user devices comprises sending of the respectively updated group.

13. The method of claim 1, wherein the first data comprises webpage code renderable by a web browser running on the respective user device, and wherein the modifying the first data comprises rendering the webpage code.

14. A method comprising:
sending at a server unit to one or more user devices first data and group of first hashes, the group comprising a subset of first hashes stored in a hash store, wherein each first hash is stored in association with a respective first data portion from which the first hash can be hashed using a hash function;
receiving at the server unit from the or each user device one or more second hashes and, for the or each second hash, a data portion from which the second hash can be generated using the hash function, wherein the or each second hash does not match with any first hash in the group;
determining for the or each second hash whether the second hash matches with one of the first hashes in the hash store;
if the respective second hash does not match with any of the first hashes, adding the second hash to the hash store as a first hash, in association with the associated data portion;
updating the group to comprises first hashes that are more likely to be received than the first hashes not in the group.

15. The method of claim 14, wherein if, based on a result of the determining, the respective second hash matches one of the first hashes in the hash store, associating, at the server unit, an indication that the second hash has been received with the matching, stored first hash, wherein the updating the group is based on the indications.

16. A method comprising:
the method of claim 14;
repeating the method of claim 14, wherein the sending of the group to the one or more user devices comprises sending of the updated group.

17. The method of claim 14, wherein the first data comprises webpage code renderable by a web browser running on the user device, and wherein the modifying the first data comprises rendering the webpage code.

18. A method comprising:
receiving from a server unit, at a user device, first data and a plurality of first hashes, wherein the first hashes are each stored in association with respective second data from which the first hash has been generated using a hashing function;
modifying the first data at the user device;
hashing at least one portion of the modified first data to generate at least one second hash using the hashing function;
determining that at least one of the second hashes matches one of the first hashes;
sending information indicative of the matched hashes and the modified first data excluding the portion to the server unit, thereby enabling the server unit to determine the modified first data.

19. The method of claim 18, further comprising, before hashing the at least one portion of the modified first data, determining at least one portion of the first data to be hashed.

20. The method of claim 18, wherein the first data comprises webpage code renderable by a web browser running on the user device, and wherein the modifying the first data comprises rendering the webpage code.

21. The method of claim 20, wherein the determining a portion of the first data to be hashed comprises determining an element of a DOM or render tree deriving from the first webpage code, wherein the hashing comprises hashing the element.
